(19) United States
(12) Patent Application Publication
(10) Pub. No.: US 2026/0178862 A1
(43) Pub. Date: Jun. 25, 2026

(54) DIGITAL PRETREATMENT OF TEXTILE OR GARMENT SYSTEM AND METHOD

(71) Applicant: M&R Printing Equipment, Inc., Roselle, IL (US)

(72) Inventors: Stephen Chuddy, Roselle, IL (US); Joe Byrne, Roselle, IL (US); Darek Tkacz, Roselle, IL (US)

(21) Appl. No.: 19/323,776

(22) Filed: Sep. 9, 2025

Related U.S. Application Data
(60) Provisional application No. 63/692,687, filed on Sep. 9, 2024.

(51) Int. Cl. G06K 15/02; B41J 2/21; B41J 3/407; B41J 11/00; B41J 29/393; D06P 5/30

(52) U.S. Cl. CPC G06K 15/1876; B41J 2/2117; B41J 3/4078; B41J 11/0015; B41J 29/393; D06P 5/30; G06K 15/021; G06K 15/1881; G06K 2215/101

(57) ABSTRACT

A digital pretreatment system and method for preparing textile or garment substrates for printing are disclosed. The system includes a digital printer having at least one inkjet print head fluidly coupled to a reservoir of pretreatment solution and configured to receive a digital artwork file. The artwork file represents a silhouette of an image area to be printed and may be transmitted via removable media, a network connection, or an external computing device. An image processor, which may be integrated with or external to the printer, converts the artwork file into a pretreatment control image, such as a grayscale or dithered monochrome image, to control spatially varying application of pretreatment solution. The system can expand the silhouette outline and generate gradient transition zones to improve registration and reduce visible pretreat artifacts. Pretreatment is applied only to the designated image area, with variable density to accommodate ink coverage requirements and provide feathered edges for smooth transitions. This approach minimizes discoloration, optimizes pretreat usage, and enhances print quality for subsequent ink layers.

### CROSS-REFERENCE TO RELATED APPLICATION

The present application claims priority to and the benefit of U.S. Provisional Application No. 63/692,687, filed Sep. 9, 2024, the contents of which are incorporated herein by reference and made a part hereof.

### BACKGROUND OF THE INVENTION

The present invention generally relates to the pretreatment of textile or garment substrates in connection with direct-to-garment (DTG) printing. More particularly the invention relates to the use and application of digital printing and inkjet print heads to apply shape-for-shape pretreatment of an indicia to be printed to a textile or garment substrate.

Pretreatment fluid serves as a primer for preparing a substrate surface to be printed upon. In the case of textile fabrics, pretreatment serves the function of creating a foundation for white and color ink to sit upon and allows the inks to better bind to the surface of the fabric. Since this chemistry prevents white ink from being absorbed by the substrate, it allows an underbase of white ink to be created. (The underbase is considered the canvas layer of the print and is what allows the color ink to maintain its hue and vibrancy, even when applied to a dark substrate). While pretreat can be applied to all areas of the design, the most important function is to support the white layer of the overall print. The brightest areas of the design typically require a greater volume of white ink underneath (to assist with opacity and vibrancy), while the darker areas of a design (such as shadows) may require a minimal or non-existent volume of white ink underneath. As the required volume of white ink increases, so too does the volume of pretreat being applied to support the additional volume of white ink. Therefore, areas of the design that are brighter, would typically have more white ink underneath, and by extension, intend to have more pretreat fluid underneath.

Current pretreat application methods involve the use of spray nozzles to apply pretreat fluid in the general area where the design will ultimately be printed. They are therefore usually in the shape of a rectangle (or bounding box) around the image silhouette. For example in the case of a round target, the current technology requires that pretreat be applied in a square/rectangular area relative to the dimensions of the round target.

One of the common drawbacks to the varying formulations of pretreat chemistry, is that they can have a reaction with certain garment dyes and pigments, causing a discoloration of the garment in the areas where the pretreat chemistry has been applied. This discoloration is then noticeable in the areas of the bounding box where no ink is being applied over the top (i.e. the negative space of the design).

One current way to narrow the bounding box and potential for discoloration involves using nozzle tips that are cut to different fan angles to increase or decrease the total width of the spray. This presents additional issues such as having to adjust the system for each design as well as having to dispense the same amount of pretreatment fluid over a given area and waste pretreatment fluid.

The present invention attempts to remedy these shortcomings by providing a digital pretreatment system configured to use inkjet heads to print an accurate image silhouette onto a substrate.

### SUMMARY OF THE INVENTION

A digital pretreatment system is provided. This system utilizes a digital printer and inkjet technology to digitally print the pretreat fluid instead of conventional direct to garment (DTG) inks. The digital printer allows for a “shape-for-shape” pretreat application wherein the pretreat fluid is applied exactly in the shape of the target, as opposed to a bounded box (as shown in FIG. 1). This assists in eliminating the excess pretreat that would otherwise be applied to the areas of the bounding box that fall outside of the design shape. One of skill in the art would recognize that the terms pretreatment or pretreat may include the terms binder-less pretreatment, fixation, fix, foundation, prime, all as fluids to be applied to a garment/textile substrate prior to the deposition of color/white ink.

The present disclosure relates to a digital pretreatment system and method for preparing textile or garment substrates for subsequent printing. The system includes a digital printer having at least one inkjet print head fluidly coupled to a reservoir of pretreatment solution and configured to receive a digital artwork file. The artwork file may be transmitted to the printer, for non-limiting examples through via removable media, such as a memory card or USB device, or through a network connection from an external computing device.

An image processor, which may be integrated with or external to the printer, processes the digital artwork file to generate a pretreatment control image. In some embodiments, the image processor converts the artwork file into a silhouette of the image area to be printed and further into a grayscale or dithered monochrome image. This control image enables spatially variable application of pretreatment solution, allowing smooth transitions and optimized pretreatment density based on design characteristics or anticipated ink coverage. For example, higher pretreatment density may be applied where white ink will be printed, and lower density where only color ink is used. The mapping of grayscale intensity to pretreatment laydown may be implemented using a lookup table (LUT) or tone curve, providing multiple discrete levels of control.

In certain embodiments, the system expands the silhouette outline to create an enlarged region and generates a gradient transition zone within this region. This gradient zone provides a feathered edge that reduces visible pretreatment artifacts and aids in registration of subsequent ink layers. The expanded region may be defined by a fixed pixel offset or a percentage of the original design size. The feathered edge may be algorithmically generated by applying a gradient mask to the expanded silhouette region.

The printer may vary pretreatment application by controlling one or more parameters, including drop volume, nozzle firing frequency, carriage speed, or selective nozzle activation, based on the grayscale or dithered control image. The substrate may be positioned under the print heads on a conveyor or fixed pallet, or the print heads may move relative to the substrate.

The disclosed method includes preparing a digital artwork file representing a silhouette of an image to be printed, transmitting the file to the digital printer, and printing the silhouette using pretreatment solution through the inkjet print head. The method may further include converting the silhouette into a grayscale or dithered image to control pretreatment density, expanding the silhouette outline to create a gradient transition zone, and adjusting pretreatment application based on anticipated ink coverage. In some embodiments, a secondary image processor receives image data from a raster image processor (RIP) and generates modified images such as grayscale, dithered, or expanded-outline images for pretreatment control.

### BRIEF DESCRIPTION OF THE DRAWINGS

In the accompanying figures, like elements are identified by like reference numerals among the several preferred embodiments of the present invention.

FIG. 1 illustrates a prior art example of pretreatment laydown.

FIG. 2 illustrates a digital artwork filed transformed into a silhouette.

FIG. 3 illustrates a digital artwork filed transformed into a grayscale/dithered image.

FIG. 4 illustrates a digital artwork filed transformed into a grayscale/dithered image with expanded feathered edges.

FIG. 5 illustrates an example direct to garment printing system.

FIG. 6 illustrates an example stand alone pretreatment system.

FIG. 7 illustrates an example pretreatment process.

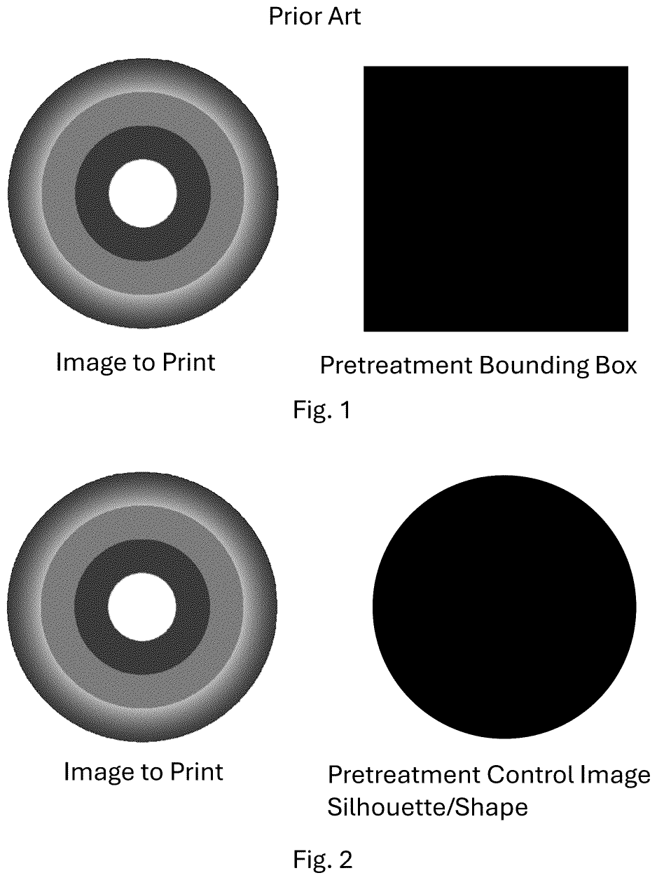

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of an exemplary embodiment, read in conjunction with the accompanying drawings. The detailed description and drawings are merely illustrative of the invention rather than limiting, the scope of the invention being defined by the appended claims and equivalents thereof.

The digital pretreatment system comprises a digital printer having at least one inkjet print head, a fluid reservoir containing pretreat solution coupled to the inkjet print head, and a means to receive a digital artwork file. In one aspect the digital pretreatment system may comprise a reader for removable memory such as a memory card slot, USB port, or similar communications port. In other aspects, the system may be communicatively coupled to an external computing device or a network configured to transmit the digital art file to the digital printer.

In operation, a digital artwork file containing an electronic representation of the artwork to be printed on a finalized substrate is converted into a pretreatment control image. In some aspects, the control image is a silhouette of the printable area of the digital artwork file. FIG. 2 show an example of the printable digital artwork file converted to a pretreatment control image as a silhouette of the digital artwork file. The control image is then transmitted to or otherwise stored on the digital printer. To this end, an image processor, such as a raster image processor (RIP) controls a portion of the printing process and specifically is able to print from a control image file, loaded into memory of the RIP, containing an electronic representation of the desired silhouette to be printed. In addition to the memory, the RIP has a processor and a memory for storing computer-readable instructions for converting the digital art file representing the pretreat layer location. The RIP sends a first signal representative of the pretreat solution the digital printer for preparing to print the converted image onto the substrate. The image processor is configured to restrict the application of pretreat specifically to the control image design area, thereby eliminating the negative characteristics of pretreat chemistry (discoloration). The image processor may be coupled or integral to the digital printer, or be external to the digital printer and configured to transmit the converted art file to the printer. In one aspect, the digital artwork file is pre-processed externally to be a control image, while in other aspects the RIP or onboard processor converts a digital artwork file into a control image at the digital printer level.

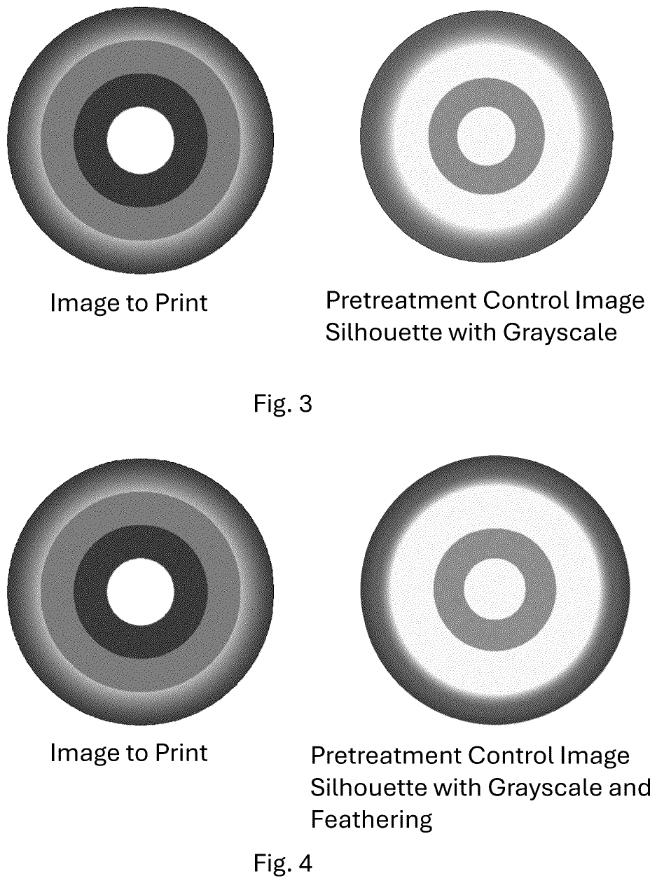

In yet another aspect of the system, as shown in FIG. 3 the digital artwork file is processed into a grayscale image or dithered monochrome control image, simulating the effect of greyscale. The image processor transmits a grayscale image or dithered monochrome image, simulating the effect of greyscale, instructing the printer to vary the application and density/volume of the pretreat solution onto the substrate. In this example, smooth transitions can be made to control desired pretreat volume. In another example the image processor may generate and transmit a grayscale image or dithered monochrome image varying the pretreat volume according to the composition of the other ink layers that will later be printed on top. Specifically, the image processor may provide control to adjust the printed pretreat density for areas when only color ink, versus white ink, will be used to build the image printed on top. The image processor may adjust pretreatment density based on anticipated ink coverage, applying higher pretreatment where white ink will be printed and lower pretreatment where only color ink is used. In some embodiments, the image processor applies a mapping function, such as a lookup table (LUT) or tone curve, to relate pixel intensity values of the grayscale or dithered image to corresponding pretreatment laydown amounts. For example, an 8-bit grayscale image may define 256 discrete levels of pretreatment density, where brighter pixels correspond to higher or lower laydown depending on the selected mapping.

In yet another aspect of the system, the digital artwork file is processed into a control image having an expanded outline of the original silhouette adding a grayscale, gradient, or dithered monochrome expanded outline. Further, the grayscale/dithered monochrome support allows for a unique method of applying a spread to the pretreat area (making it slightly larger than the silhouette of the design), and then applying a gradual feathering (reduction), as shown in FIG. 4, of the pretreat solution over the pretreat area. This functions to assist in potential registration issues when the ink layer is applied later in the printing process. In the example of the round target, this means that areas of the round target which may require differing volumes of the fluid, can have this variation, while still maintaining the overall shape of the round target. This is seen as a variation in density of the pretreat application. The expanded region may be defined by a predetermined offset, such as a fixed number of pixels or a percentage of the original design size. Within this region, the image processor may generate a gradient transition zone where pretreatment density decreases monotonically from the silhouette edge outward, forming a feathered edge.

Finally, a challenge in aligning the pretreat layer and in fading a design out to the substrate, is the appearance of pretreat chemistry where there are very light (minimal) deposits of ink. The technology and related algorithms used in this approach allow for a reduction (or fade) in the volume of pretreat being applied as the volume of ink reduces on top. This is referred to as a “feathered edge,” where the edge of the design has a gradation in the volume of pretreat chemistry being applied. This results in a smooth transition to the garment surface, as well as a reduction in the total volume of pretreat required to produce a printed design. This feathered edge may be generated algorithmically by applying a gradient mask to the expanded silhouette region, reducing pretreatment density progressively toward the outer edge.

The printer may vary pretreatment application by controlling one or more of: drop volume, nozzle firing frequency, carriage speed, or selective nozzle activation. These parameters may be adjusted dynamically based on the grayscale or dithered control image.

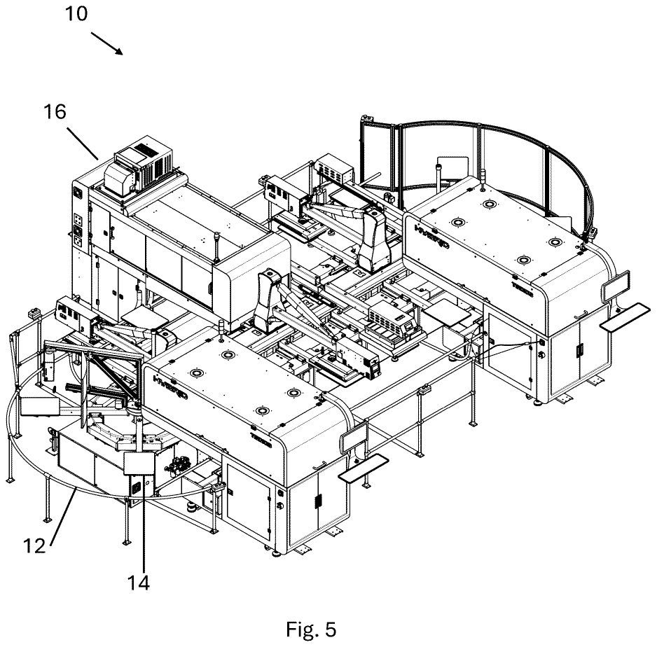

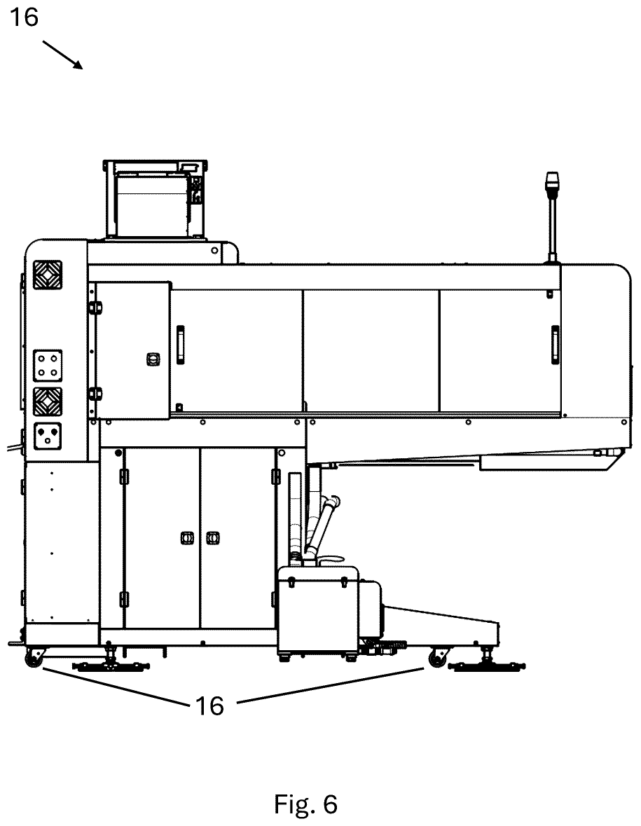

In one aspect, the substrate can be positioned under the digital pretreat print heads and can either be moved relative to the digital pretreat print heads on a conveyor, or in another aspect the digital pretreat print heads can move relative to the substrate fixed on a pallet or mounting surface of the digital pretreat printer. FIG. 5 shows a direct to garment printing system 10 having an oval/circular track or rail 12 about which a series of pallets 14 supporting a work piece are indexed from station to station. The arrangement is such that the pallets 14 travelling about the oval or round rail 12 are maintained in a common plane. There are a variety of station types shown in the figure. The digital printer 16 configured for pretreatment 10 can be a separate, independent unit, part of a larger DTG system, or an independent unit, as shown in FIG. 6, that is moved into position during print set up for printing in a printing zone of a substrate or textile. The independent unit can include a set of casters or slides 18 for ease of movement.

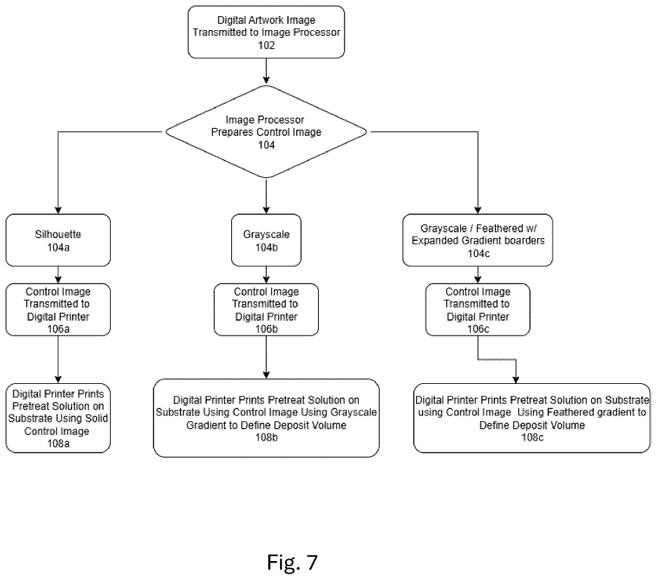

In an example method of using the digital pretreatment system, the steps may comprise preparing a digital artwork file of a silhouette of an image to be printed onto a textile or garment substrate, transmitting the artwork file to a digital printer comprising of an inkjet print head and a pretreatment solution reservoir coupled to the inkjet print head, and printing the silhouette art file using the pretreatment solution onto the substrate through the inkjet print head. Preparing the digital artwork file may further comprise the steps of converting the silhouette into a grayscale or dithered monochrome image file that is configured to dispense a varying volume of pretreat fluid (less or more), depending on the darker or lighter areas of the design, as well as where transitions may be present. One of skill in the art would recognize that depending on how the digital art file is configured, a brighter area of the image could require a higher density of pretreat solution and a darker area could relay a lower density. Preparing the digital artwork file may in conjunction with or alternatively expand the silhouette outline and prepare a gradient transition zone in the expanded region to aid in registration for subsequent printing layers. In some aspects a second image processor is used to process the silhouette images received from a standard image processor or RIP to generate the silhouette or gradient/expanded/grayscale/dithered images. In some aspects, a secondary image processor receives silhouette or full-color images from a raster image processor (RIP) and generates modified images such as grayscale, dithered, or expanded-outline images for pretreatment control. FIG. 7 shows an example process further comprising the steps of transmitting digital artwork to an image processor 102, the image processor preparing the control image 104, the control image prepared as a silhouette 104a of the digital artwork, or the control image prepared as a grayscale 104b of the digital artwork, or the control image prepared as a grayscale with expanded feathered gradient edges 104c of the digital artwork, the processed control image is transmitted to the digital printer 106a, 106b, 106c, the digital printer prints pretreat solution onto the substrate using solid silhouette boundary 108a, or the digital printer prints pretreat solution onto the substrate using the control image grayscale gradient to define deposit volume in transition zones 108b, or the digital printer prints pretreat solution onto the substrate using control image's feathered gradient to define deposit volume in transition zones 108c.

Those of ordinary skill in the art will understand and appreciate the aforementioned description of the invention has been made with reference to a certain exemplary embodiment of the invention, which describe a digital pretreatment system and method of use. Those of skill in the art will understand that obvious variations in construction, material, dimensions or properties may be made without departing from the scope of the invention which is intended to be limited only by the claims appended hereto.

1. A digital pretreatment system comprising:
a digital printer having an inkjet print head and a fluid reservoir comprising pretreatment solution fluidly coupled to the inkjet print head;
an image processor coupled to the digital printer configured to receive a digital artwork file and transmit the digital artwork file to the digital printer, the image processor further configured to process the digital artwork file into at least one or combination of a silhouette, a silhouette having grayscale or dithered monochrome components, a silhouette having an expanded scaled perimeter, or a silhouette having an expanded scaled perimeter wherein the expanded area is a gradient; and
wherein the digital printer is configured to print the processed digital artwork using the pretreatment solution through the inkjet print head onto a substrate.

2. The digital pretreatment system of claim 1 wherein the grayscale or dithered monochrome components reside within the silhouette and lighter areas of the grayscale or dithered monochrome components correspond with a less dense deposition of pretreatment solution than darker areas of the grayscale or dithered monochrome components.

3. The digital pretreatment system of claim 1 wherein the grayscale or dithered monochrome components reside within the silhouette and darker areas of the grayscale or dithered monochrome components correspond with a less dense deposition of pretreatment solution than lighter areas of the grayscale or dithered monochrome components.

4. The digital pretreatment system of claim 1 wherein the gradient comprises a reduced density of printed pixels, or grayscale or dithered monochrome components.

5. The digital pretreatment system of claim 1 wherein the grayscale or dithered monochrome components are processed and generated by the image processor and transmitted to the digital printer according to the color of ink to be printed on top of a pretreat layer.

6. The digital pretreatment system of claim 5 wherein the required volume of pretreatment solution is increased if the color of ink to be printed on top of the pretreat layer is white.

7. A method of digitally pretreating a textile or garment substrate for subsequent printing, the method comprising:
preparing, by an image processor, a digital artwork file comprising an image to be printed on a substrate;
converting, by the image processor, the digital artwork file into a pretreatment control image that is either a silhouette, grayscale or dithered monochrome, image and encodes spatially varying application amounts of a pretreatment solution across the pretreatment control image;
transmitting the pretreatment control image to a digital printer comprising an inkjet print head fluidly coupled to a reservoir of the pretreatment solution; and
jetting the pretreatment solution through the inkjet print head onto the substrate in accordance with the pretreatment control image to deposit differing local quantities of the pretreatment solution over the pretreatment control image.

8. The method of claim 7, wherein converting comprises mapping pixel intensity of the pretreatment control image to pretreatment laydown such that brighter pixels correspond to higher laydown than darker pixels.

9. The method of claim 7, wherein converting comprises mapping pixel intensity of the pretreatment control image to pretreatment laydown such that brighter pixels correspond to lower laydown than darker pixels.

10. The method of claim 7, wherein converting comprises halftone dithering a binary silhouette to produce a monochrome raster that controls drop placement and local coverage of the pretreatment solution.

11. The method of claim 7, wherein jetting comprises controlling at least one of drop volume, firing frequency, nozzle firing count, carriage speed, or dot placement based on the pretreatment control image.

12. The method of claim 7, further comprising expanding an outline of the pretreat control image to define an expanded region surrounding a perimeter of the pretreat control image.

13. The method of claim 12, further comprising generating, within the expanded region, a gradient transition zone of pretreatment laydown that varies from a first density adjacent the silhouette to a second density away from the silhouette.

14. The method of claim 13, wherein the gradient transition zone varies monotonically from the first density to the second density.

15. The method of claim 12, wherein the expanded region has a width defined as a predetermined number of pixels in the pretreatment control image.

16. The method of claim 7, wherein the pretreatment control image is generated an image processor configured to output at least one of: a silhouette image, a gradient-expanded image, a grayscale image, or a dithered image.

17. The method of claim 16, wherein the image processor automatically detects an edge of the digital artwork file using at least one of thresholding, vectorization, or a distance transform.

18. The method of claim 7, wherein transmitting comprises sending printer-ready raster data to the digital printer and associating the pretreatment control image with a pretreatment fluid channel.

19. The method of claim 7, further comprising, after jetting the pretreatment solution, printing one or more subsequent ink layers that register to the silhouette or to the gradient transition zone.

20. The method of claim 19, wherein the subsequent printing is performed in-line by the same digital printer.

21. The method of claim 7, wherein the substrate comprises a textile, garment, or fabric article.

22. The method of claim 7, wherein the pretreatment control image comprises multiple gray levels corresponding to at least three distinct laydown levels of the pretreatment solution.

23. The method of claim 7, wherein converting includes applying a lookup table or tone curve defining the relationship between pixel intensity and local pretreatment laydown.

24. The method of claim 7, wherein jetting includes selectively enabling or disabling subsets of nozzles of the inkjet print head in accordance with the pretreatment control image.

25. The method of claim 7, wherein the pretreatment control image comprises an 8-bit per pixel grayscale raster.

26. The method of claim 7, wherein preparing the digital artwork file comprises removing interior detail from an input image to produce the silhouette.

27. A digital pretreatment system for preparing a textile or garment substrate for printing, the system comprising:
a digital printer including at least one inkjet print head;
a fluid reservoir containing a pretreatment solution and fluidly coupled to the inkjet print head;
a memory configured to store a digital artwork file representing a silhouette of an image area to be printed; and
an image processor configured to convert the digital artwork file into a pretreatment control image and to control the inkjet print head to apply the pretreatment solution to the substrate in accordance with the pretreatment control image.

28. The system of claim 27, wherein the image processor converts the digital artwork file into a grayscale or dithered monochrome image to control spatially varying application of the pretreatment solution.

29. The system of claim 28, wherein the image processor applies a mapping function, lookup table (LUT), or tone curve to relate pixel intensity values of the grayscale or dithered image to corresponding pretreatment laydown amounts.

30. The system of claim 28, wherein the grayscale or dithered image defines multiple gray levels corresponding to at least three distinct pretreatment laydown levels.

31. The system of claim 27, wherein the image processor is configured to adjust pretreatment density based on anticipated ink coverage, applying higher pretreatment where white ink will be printed and lower pretreatment where only color ink is used.

32. The system of claim 27, wherein the image processor or the digital printer is configured to expand an outline of the silhouette to create an expanded region surrounding the silhouette.

33. The system of claim 27, wherein the expanded region is defined by a predetermined offset measured in pixels or as a percentage of the original design size.

34. The system of claim 32, wherein the image processor generates a gradient transition zone within the expanded region, the gradient transition zone having pretreatment density that decreases monotonically from the silhouette edge outward.

35. The system of claim 34, wherein the gradient transition zone forms a feathered edge to reduce visible pretreatment artifacts and aid registration of subsequent ink layers.

36. The system of claim 27, wherein the image processor is configured to restrict application of pretreatment solution to the silhouette of the design area.

37. The system of claim 27, wherein the image processor is configured to generate a pretreatment control image based on a full-color image by removing interior detail to produce the silhouette.

38. The system of claim 27, wherein the image processor comprises a raster image processor (RIP) or is configured to receive image data from a RIP.

39. The system of claim 38, further comprising a secondary image processor configured to receive silhouette or full-color images from the RIP and generate modified images including at least one of: a grayscale image, a dithered image, or an expanded-outline image.

40. The system of claim 27, wherein the pretreatment control image is stored as an 8-bit per pixel grayscale raster or as a halftone bitmap.

41. The system of claim 27, wherein the printer is configured to vary pretreatment application by controlling one or more of: drop volume, nozzle firing frequency, carriage speed, or selective nozzle activation.

42. The system of claim 27, wherein the printer includes a reader for removable memory selected from a memory card slot or USB port.

43. The system of claim 27, wherein the printer is communicatively coupled to an external computing device or a network for receiving the digital artwork file.

44. The system of claim 27, wherein the substrate is positioned under the inkjet print head on a conveyor or on a fixed pallet, and the inkjet print head is configured to move relative to the substrate.

45. The system of claim 27, wherein the image processor is configured to generate a pretreatment control image that varies pretreatment density according to the composition of ink layers to be printed on top.

46. The system of claim 27, wherein the image processor is configured to apply a gradient mask to the expanded silhouette region to algorithmically generate a feathered edge.
